(19) United States
(12) Patent Application Publication
(10) Pub. No.: US 2011/0056662 A1
(43) Pub. Date: Mar. 10, 2011

(54) REFRIGERANT COOLING APPARATUS

(75) Inventors: Masahiro Yonekura, Toyko (JP); Masahiro Takeuchi, Tokyo (JP)

(73) Assignee: TSIYO NIPPON SANSO CORPORATION, Shinagawa-ku (JP)

(21) Appl. No.: 12/733,546

(22) PCT Filed: May 18, 2009
(86) PCT No.: PCT/JP2009/059137

§ 371 Date: Mar. 8, 2010

(30) Foreign Application Priority Data
May 28, 2008 (JP) 2008-13995

(51) Int. Cl. F28D 7/10; G05D 23/00

(52) U.S. Cl. 165/154; 165/300

(57) ABSTRACT

A refrigerant cooling apparatus is provided, in which a circulating refrigerant may be cooled to a prescribed temperature efficiently in a stable condition even when the cooling temperature of the circulating refrigerant is near the freezing point of the circulating refrigerant. This apparatus is one which cools the circulating refrigerant by countercurrent indirect heat exchange between a circulating refrigerant which cools objects to be cooled such as a low temperature reaction vessel 11 and a cryogenic liquid in a heat exchanger 17, wherein a first flow control means 23 which controls the amount of cryogenic liquid supplied by detecting the temperature of the circulating refrigerant allowed to flow out from the heat exchanger 17 with a first temperature detecting means 20 and a second flow control means 25 which controls the amount of cryogenic liquid supplied by detecting the heating surface temperature at the inside of the heat exchanger with a second temperature detecting means 21 are arranged in series on a cryogenic liquid inflow path 16 which provides the cryogenic liquid to the heat exchanger.

### FIELD OF INVENTION

The present invention relates to a refrigerant cooling apparatus, and particularly to a refrigerant cooling apparatus in which a refrigerant used as a cooling source for a low temperature reaction of, for example, fine chemicals in chemical engineering is cooled by exchanging heat in a heat exchanger using a cryogenic liquid as a cooling source.

### BACKGROUND ART

In order to remove heat of reaction generated by chemical reactions, a refrigerant, which is generally called brine, comprising methanol, ethanol, ketones, amines, silicone oils, organic halides or the like, or a mixture thereof is used and recycled. As the cooling source for cooling such a refrigerant which is used and recycled (circulating refrigerant) to a low temperature region, such as not higher than −50° C., which is hard to be attained by a normal refrigerator, various cryogenic liquids such as liquid nitrogen or liquid air are used. By exchanging heat between a cryogenic liquid and a circulating refrigerant in a heat exchanger, the circulating refrigerant is cooled to a prescribed temperature.

Further, in order to control the temperature of a circulating refrigerant at a prescribed temperature, a plurality of temperature sensors which detect the temperature of a refrigerant which flows through a refrigerant flow path in a heat exchanger are provided (see, for example, Patent Document 1); a temperature sensor and a pressure sensor are provided at a refrigerant inlet and a refrigerant outlet of a heat exchanger respectively, and a temperature sensor is provided at an exhaust gas outlet of the heat exchanger (see, for example, Patent Document 2); or the like; whereby the amount of cryogenic liquid supplied to the heat exchanger is controlled by the signals from these sensors.

### PRIOR ART REFERENCES

### Patent Documents

### [Patent Document 1] Japanese Laid-open Utility Model Application (Kokai) No. 6-22880

### [Patent Document 2] Japanese Laid-open Patent Application (Kokai) No. 11-37623

### SUMMARY OF THE INVENTION

### Problems to be Solved by the Invention

Even in the conventional temperature control, in the case that a preset temperature is enough higher than the freezing point of the circulating refrigerant, for example, in the case that the preset temperature of the circulating refrigerant reaches about −90° C. when the circulating refrigerant has a freezing point of −130 to −140° C., the temperature of the circulating refrigerant can be controlled sufficiently stably. However, the control in a lower temperature range is demanded nowadays. In cases where a circulating refrigerant is to be controlled at a lower temperature than before, it is possible that the heating surface temperature of the heat exchanger locally becomes the freezing point of the circulating refrigerant or below when the preset temperature is near the freezing point, and a part of the circulating refrigerant freezes and adheres to the heating surface not only to make the heat exchange efficiency extremely decreased, but also to make a flow path narrow, thereby hindering the flow of the circulating refrigerant, and therefore, there were some cases where a prescribed amount of circulating refrigerant may not be provided and recycled to the object to be cooled.

On the other hand, although it is possible to avoid freezing of the circulating refrigerant by adopting materials which have a low freezing point as the circulating refrigerant or by reducing the temperature difference in the heat exchanger by employing an intermediate refrigerant, there have been problems that the cost of refrigerants increases and the cost of equipments increases to a large extent.

Further, as described in Patent Document 1, although it is possible to avoid freezing of circulating refrigerant by detecting the refrigerant temperature in the heat exchanger, it is difficult to control the temperature of the circulating refrigerant constant near the freezing point of the circulating refrigerant.

Accordingly, an object of the present invention is to provide a refrigerant cooling apparatus in which the circulating refrigerant may be cooled to a prescribed temperature efficiently in a stable condition even when the cooling temperature of the circulating refrigerant is near the freezing point of the circulating refrigerant.

### Means for Solving the Problems

The refrigerant cooling apparatus of the present invention is a refrigerant cooling apparatus which cools a circulating refrigerant by countercurrent indirect heat exchange in a heat exchanger between said circulating refrigerant which cools objects to be cooled and a cryogenic liquid, and which is provided with a first temperature detecting means which detects the temperature of said circulating refrigerant allowed to flow out from said heat exchanger, a first flow control means which controls the amount of said cryogenic liquid supplied which is allowed to flow in the heat exchanger depending on the temperature of said circulating refrigerant detected by said first temperature detecting means, a second temperature detecting means which detects the temperature of the heating surface of the inside of said heat exchanger, and a second flow control means which controls the amount of said cryogenic liquid supplied which is allowed to flow in the heat exchanger depending on the temperature of the heating surface detected by said second temperature detecting means, wherein said first flow control means and said second flow control means are arranged in series on a cryogenic liquid inflow path through which said cryogenic liquid is allowed to flow into said heat exchanger.

Further, the refrigerant cooling apparatus of the present invention is formed of a plurality of heat exchange units which are positioned in series, wherein at least the heat exchange unit located at the most downstream in the flow direction of said circulating refrigerant is double-pipe type, and the other heat exchange units are plate fin type or plate type, and wherein said second temperature detecting means detects the heating surface temperature of the inner tube located downstream in the flow direction of the circulating refrigerant which flows in the inner tube in the double-pipe heat exchange unit. Said second temperature detecting means is provided on the side of the circulating refrigerant of the heating surface corresponding to the inflow section of said cryogenic liquid in said heat exchanger.

### EFFECTS OF THE INVENTION

In the refrigerant cooling apparatus of the present invention, by arranging means in which the temperature of the circulating refrigerant allowed to flow out from the heat exchanger and the heating surface temperature of the inside of the heat exchanger are detected and in which the amount of cryogenic liquid supplied is controlled depending on the detected temperatures on a cryogenic liquid inflow path in series, the circulating refrigerant may be cooled to a prescribed temperature in a stable condition while avoiding partial freezing of the circulating refrigerant and adhesion to the heating surface, thereby efficiently cooling objects to be cooled.

### BRIEF DESCRIPTION OF THE DRAWINGS

FIG. 1 is a system diagram illustrating one embodiment of the refrigerant cooling apparatus of the present invention.

FIG. 2 is a schematic diagram illustrating the state of the inside of the heat exchanger.

FIG. 3 is a diagram illustrating the changes with time of the exhaust gas temperature, refrigerant temperature, heating surface temperature and pressure difference when the refrigerant cooling apparatus of the present invention is under a cooling operation.

FIG. 4 is a diagram illustrating the changes with time of the circulating refrigerant temperature and exhaust gas temperature when the conventional refrigerant cooling apparatus is under a cooling operation.

### MODE FOR CARRYING OUT THE INVENTION

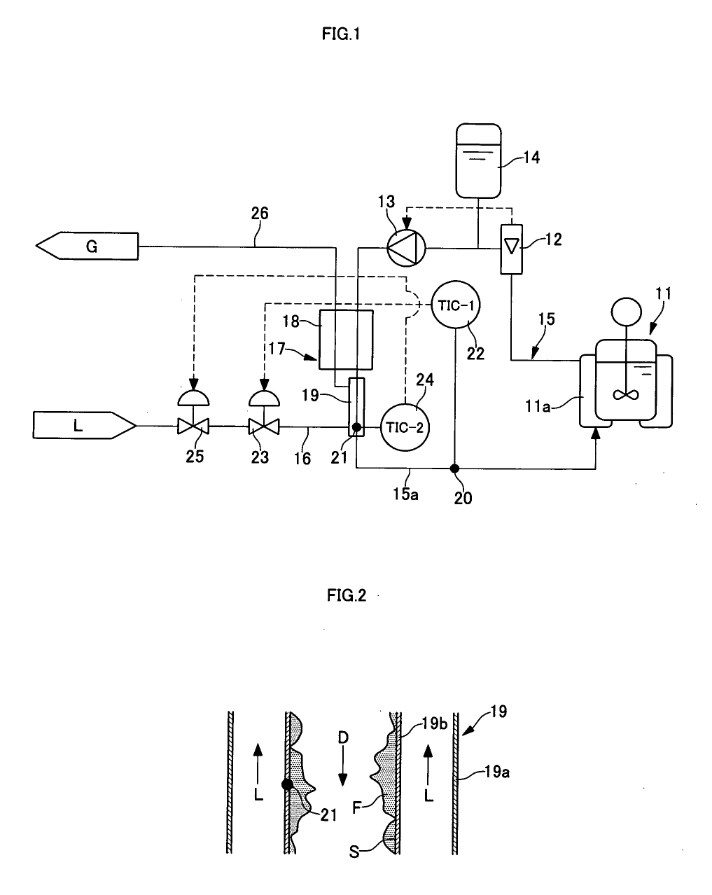

FIG. 1 is a system diagram illustrating one embodiment of the refrigerant cooling apparatus of the present invention, and FIG. 2 is a schematic diagram illustrating the state of the inside of the heat exchanger.

The refrigerant cooling apparatus of this embodiment is one which is for a cooling low-temperature circulating refrigerant used in cooling a low-temperature reaction vessel 11, such as hydrocarbon refrigerants, to a prescribed temperature by heat exchange with cryogenic liquid such as liquid nitrogen, and which is provided with a heat exchanger 17 which exchanges heat by countercurrent indirect heat exchange between a circulating refrigerant flowing in a refrigerant circulation path 15 provided with a flowmeter 12, a refrigerant circulation pump 13 and a reserve tank 14 and a cryogenic liquid L allowed to flow in from a cryogenic liquid inflow path 16.

The heat exchanger 17 is constituted by a plate fin type or plate type first heat exchange unit 18 positioned upstream in the flow direction of said circulating refrigerant in the refrigerant circulation path 15 and a double-pipe second heat exchange unit 19 positioned downstream in the flow direction of said circulating refrigerant, and so formed that the circulating refrigerant is cooled to near a preset temperature in the plate fin type or plate type first heat exchange unit 18 having an excellent heat exchange efficiency and then the circulating refrigerant is cooled to the preset temperature in the double-pipe second heat exchange unit 19.

As shown in FIG. 2, the second heat exchange unit 19 has a flow path of the cryogenic liquid L formed between an outer tube 19a and an inner tube 19b and a flow path of circulating refrigerant D formed in an inner tube 19b. On a heat exchanger outlet-side path 15a of the refrigerant circulation path 15 which is connected to the inner tube 19b at the outlet-side of the circulating refrigerant, a first temperature detecting means 20 which detects the temperature of the circulating refrigerant allowed to flow out from the heat exchanger 17 is provided. Further, at a location which is downstream in the flow direction of said circulating refrigerant which flows in the inner tube 19b and where the temperature of the circulating refrigerant is lowest, or in the vicinity thereof, a second temperature detecting means 21 which detects the heating surface temperature on the side of the circulating refrigerant flow path which is the internal circumferential surface of the inner tube 19b is provided. When the second heat exchange unit 19 is countercurrent type, the second temperature detecting means 21 is generally provided at the outlet section of the second heat exchange unit 19 in the flow path of the circulating refrigerant D, which is corresponding position to the inflow section where a cryogenic liquid flows into the flow path of the cryogenic liquid L.

In the meantime, in the cryogenic liquid inflow path 16, a first flow control means 23 which is controlled by a first temperature indicating controller (TIC-1) 22 which is operated depending on the refrigerant temperature detected by the first temperature detecting means 20 and a first set temperature value which is set in advance, and a second flow control means 25 which is controlled by a second temperature indicating controller (TIC-2) 24 which is operated depending on the heating surface temperature detected by the second temperature detecting means 21 and a second set temperature value which is set in advance are arranged in series.

The circulating refrigerant is discharged at a certain amount from a refrigerant circulation pump 13 which is operated depending on the flow rate detected by the flowmeter 12 to be allowed to flow into the heat exchanger 17. In the heat exchanger 17, the circulating refrigerant is firstly cooled to a temperature slightly higher than a preset temperature in the first heat exchange unit 18 on the upstream side which is plate fin type or plate type, and then cooled to the preset temperature in the second heat exchange unit 19 on the downstream side which is double-pipe heat exchanger type. The circulating refrigerant which is cooled to the preset temperature circulates in the refrigerant circulation path 15 such that the circulating refrigerant is allowed to flow into a jacket 11a of the low-temperature reaction vessel 11, which is an object to be cooled, to cool the low-temperature reaction vessel 11 and then sucked by the refrigerant circulation pump 13 by way of the flowmeter 12. The circulating refrigerant in the reserve tank 14 flows in and out of the refrigerant circulation path 15 depending on the volume change of the circulating refrigerant by the temperature.

The cryogenic liquid is allowed to flow in from the cryogenic liquid inflow path 16 to the heat exchanger 17 from the outlet-side of the circulating refrigerant of the heat exchanger 17 via the first flow control means 23 and the second flow control means 25, and cools the circulating refrigerant by countercurrent indirect heat exchange with the circulating refrigerant in the second heat exchange unit 19 and the first heat exchange unit 18. Vaporized cryogenic liquid due to temperature rise by cooling the circulating refrigerant is allowed to flow out from the first heat exchange unit 18 to an exhaust gas outflow path 26 as an exhaust gas G.

When the circulating refrigerant is cooled to a preset temperature by the cryogenic liquid in the heat exchanger 17 in such a way, a preset temperature of the circulating refrigerant is input to a first temperature indicator controller 22 as the first set temperature value, and the freezing point (the melting point) or a temperature near the freezing point of the circulating refrigerant is input to a second temperature indicator controller 24 as the second set temperature value. When a shut-off valve, which is subjected to on/off control (open/close control), is employed for both the first flow control means 23 and the second flow control means 25, the control of the first flow control means 23 by the first temperature indicator controller 22 is performed such that the valve opens when the refrigerant temperature detected by the first temperature detecting means 20 is higher than the first set temperature value, and the valve closes when the refrigerant temperature is lower than the first set temperature value.

Likewise, the control of the second flow control means 25 by the second temperature indicator controller 24 is performed such that the valve opens when the heating surface temperature detected by the second temperature detecting means 21 is higher than the second set temperature value, and the valve closes when the heating surface temperature is lower than the second set temperature value.

That is, by controlling each of the first flow control means 23 and the second flow control means 25 which is arranged on the cryogenic liquid inflow path 16 in series depending on the refrigerant temperature detected by the first temperature detecting means 20 and the heating surface temperature detected by the second temperature detecting means 21, it can be prevented that a part of the circulating refrigerant be frozen in the inner tube 19b even when the preset temperature is near the freezing point of the circulating refrigerant, and heat exchange can be efficiently performed in a stable condition without interfering the flow of the circulating refrigerant due to adhesion of a large amount of frozen substance F to a heating surface S as shown in FIG. 2 or without decreasing the heat exchange efficiency.

It may be also possible to employ only one double-pipe heat exchange unit for the heat exchanger 17, and by positioning a plate fin type or plate type heat exchange unit 18 which has a larger heating surface and a higher heat exchange efficiency than a double-pipe heat exchange unit on the upstream side in the flow direction of the circulating refrigerant, the circulating refrigerant whose temperature is rising can be cooled efficiently, the miniaturization of the whole heat exchanger is attained and the consumption of the cryogenic liquid may be decreased.

Further, although the mounting location of the second temperature detecting means 21 is arbitrary and the number of the second temperature detecting means 21 to be installed is also arbitrary, the installation of the second temperature detecting means 21 on the side of the circulating refrigerant of the heating surface corresponding to the outlet portion at which the temperature of the refrigerant in the second heat exchange unit 19 is lowest or in the vicinity of the outlet portion or, in the case of an alternating type heat exchange unit, corresponding to a portion where the cryogenic liquid flows into the cryogenic liquid flow path, ensures the control of the second flow control means 25 by a single temperature detecting means (temperature sensor) because the heating surface temperature of the portion where the probability that the circulating refrigerant freezes and adheres to is highest can be detected.

Further, the constitution of the heat exchanger and the number of the heat exchangers to be installed are arbitrary, and when a plurality of heat exchange units are installed, a double-pipe heat exchange unit which ensures measurement of the heating surface temperature is positioned at the most downstream in the flow direction of the circulating refrigerant. The flow control means is not limited to shut-off valves which control an open/close control, and it may be a flow adjustment valve which can perform flow adjustment. Further, the positional relationship between the first flow control means and the second flow control means in the cryogenic liquid inflow path is arbitrary and either of them may be positioned on the upstream side. The heat exchange method in each of the heat exchange units may be countercurrent or concurrent, or immersion method.

### Example 1

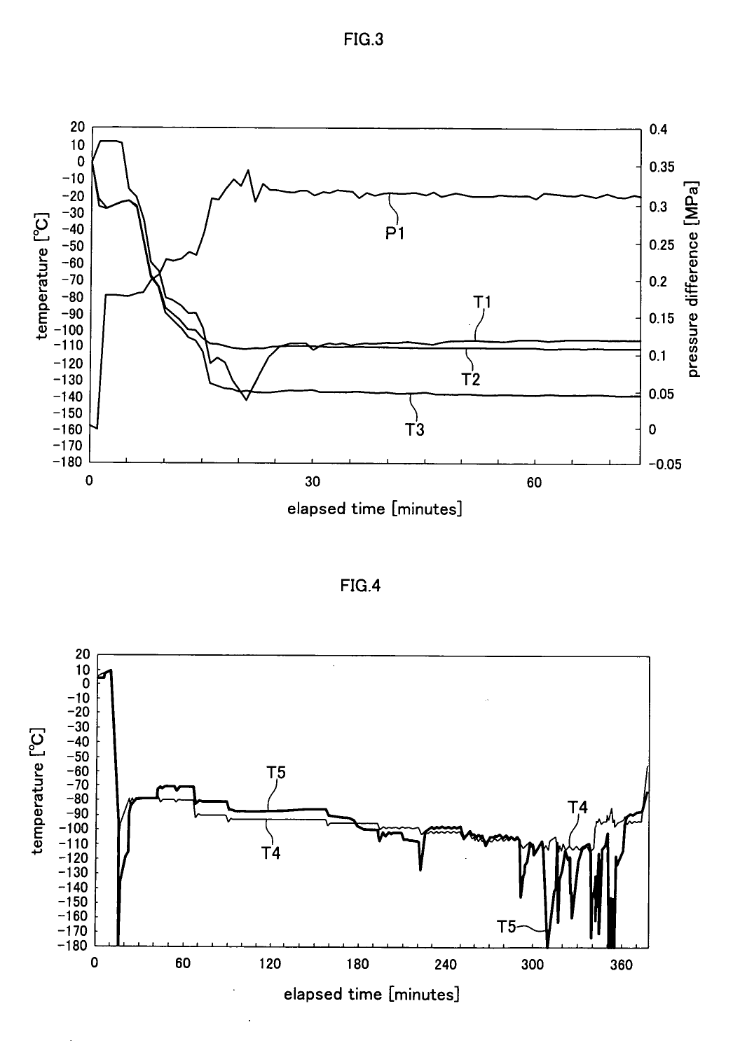

By using a refrigerant cooling apparatus which has the constitution as shown in the embodiment, and by using a circulating refrigerant having a freezing point of −136° C. as the circulating refrigerant, the low-temperature reaction vessel was subjected to a cooling operation. The cooling operation was performed by setting the set temperature value of the first temperature indicator controller to −110° C. and the set temperature value of the second temperature indicator controller to −136° C., and by circulating the circulating refrigerant at a constant flow rate. The changes with time of the exhaust gas temperature T1, the refrigerant temperature T2 detected by the first temperature detecting means, the heating surface temperature T3 detected by the second temperature detecting means and the pressure difference P1 of the circulating refrigerant between the pressures before and after the heat exchanger are illustrated in FIG. 3. As is apparent from FIG. 3, it can be seen that each of the detected values was stabilized 30 minutes after the start of the cooling operation and that the circulating refrigerant can be cooled to a temperature of −110° C. in a stable condition and supplied to the low temperature reaction vessel at a constant flow rate.

On the other hand, a cooling operation was performed by employing a conventional refrigerant cooling apparatus having the constitution described in the above-mentioned Patent Document 2 and by stepwisely changing the set temperature value of the first temperature indicator controller in the refrigerant cooling apparatus from −80° C. to −110° C. The changes with time of the circulating refrigerant temperature T4 detected by the refrigerant temperature detecting unit and the exhaust gas temperature T5 detected by the vaporized gas temperature detecting section are shown in FIG. 4.

In FIG. 4, it can be seen that, although the circulating refrigerant was capable of being cooled stably to a temperature corresponding to each of the set temperature values when the set temperature value of the first temperature indicator controller was in a range of −80° C. to −95° C. (a range of 30 minutes to 190 minutes after the start of the operation), the temperature of the circulating refrigerant was unstable when the set temperature value of the first temperature indicator controller was set to a low temperature not higher than −95° C., and that the circulating refrigerant was not capable of being cooled to −110° C. in a stable condition due to sudden changes of the temperature of the exhaust gas when the set temperature value was set to −110° C. (290 minutes after the start of the operation).

### DESCRIPTION OF SYMBOLS

11 low temperature reaction vessel
11a jacket
12 flowmeter
13 refrigerant circulation pump
14 reserve tank
15 refrigerant circulation path
15a heat exchanger outlet-side path
16 cryogenic liquid inflow path
17 heat exchanger
18 first heat exchange unit
19 second heat exchange unit
19a outer tube
19b inner tube
20 first temperature detecting means
21 second temperature detecting means
22 first temperature indicator controller
23 first flow control means
24 second temperature indicator controller
25 second flow control means
26 exhaust gas outflow path

1. A refrigerant cooling apparatus which cools a circulating refrigerant by countercurrent indirect heat exchange in a heat exchanger between said circulating refrigerant which cools objects to be cooled and a cryogenic liquid, and which is provided with a first temperature detecting means which detects the temperature of said circulating refrigerant allowed to flow out from said heat exchanger, a first flow control means which controls the amount of said cryogenic liquid supplied which is allowed to flow in the heat exchanger depending on the temperature of said circulating refrigerant detected by said first temperature detecting means, a second temperature detecting means which detects the temperature of the heating surface of the inside of said heat exchanger, and a second flow control means which controls the amount of said cryogenic liquid supplied which is allowed to flow in the heat exchanger depending on the temperature of the heating surface detected by said second temperature detecting means, wherein said first flow control means and said second flow control means are arranged in series on a cryogenic liquid inflow path through which said cryogenic liquid is allowed to flow into said heat exchanger.

2. The refrigerant cooling apparatus according to claim 1, wherein said heat exchanger is formed of a plurality of heat exchange units which are positioned in series, wherein at least the heat exchange unit located at the most downstream in the flow direction of said circulating refrigerant is double-pipe type, and the other heat exchange units are plate fin type or plate type, and wherein said second temperature detecting means detects the heating surface temperature of the inner tube located downstream in the flow direction of the circulating refrigerant which flows in the inner tube in the double-pipe heat exchange unit.

3. The refrigerant cooling apparatus according to claim 1 herein said second temperature detecting means is provided on the side of the circulating refrigerant of the heating surface corresponding to the inflow section of said cryogenic liquid in said heat exchanger.

4. The refrigerant cooling apparatus according to claim 2 herein said second temperature detecting means is provided on the side of the circulating refrigerant of the heating surface corresponding to the inflow section of said cryogenic liquid in said heat exchanger.
